(19) United States
(12) Patent Application Publication
(10) Pub. No.: US 2005/0211937 A1
(43) Pub. Date: Sep. 29, 2005

(54) Method of sealing machine components

(76) Inventor: Peter Ovidiu Popadiuc, Pontiac, MI (US)

Correspondence Address: Peter O. Popadiuc, Apt. 309, 1293 Circle Dr., Pontiac, MI, 48340, US

(21) Appl. No.: 11/024,310

(22) Filed: Dec. 28, 2004

Related U.S. Application Data
(60) Provisional application No. 60/532,730, filed on Dec. 29, 2003.

(51) Int. Cl. F16K 31/02

(52) U.S. Cl. 251/129.06; 257/415

(57) ABSTRACT

This application relates to a method of sealing machine components using electroactive materials that can be energized through a separate electric circuit or electric field in order to eliminate most friction and deformation losses during a sealing process.

### FIELD OF THE INVENTION

This invention relates to a method of sealing machine components using electroactive materials. These materials are generally polymers and have the property of changing their geometry and dimensions when subjected to a voltage or electrical field.

### BACKGROUND OF THE INVENTION

Sealing concepts are typically based on compression and interference of some sealing surfaces or deformation of a generally elastic material placed between them in order to perform sealing. Movable machine components sealing requires additional energy consumption and oversized actuators in order to overcome the frictions that accompany sealing processes. For example, in the case of a butterfly valve, a bubble tight sealing between the disc and valve's body may consist of interference between the disc's circumference and a soft material on the valve's body. Material interference drives supplementary energy consumption generally provided by oversized actuators that are capable of providing the extra energy in order to overcome friction loses.

In the past, several devices using electroactive materials where invented, but none were developed for the purpose of sealing machine components. The following U.S. Pat. Nos. 6,109,852; 6,249,076; 6,405,532; 6,475,639; 6,495,642; 6,545,384; 6,569,654; 6,583,533; 6,586,859; 6,626,417; 6,679,836; 6,664,718; 6,682,500 relate to a variety of electroactive polymer devices and their specific fields of application.

### BRIEF SUMMARY OF THE INVENTION

A first objective of this invention is to define a sealing method that virtually eliminates most friction and deformation losses during a sealing process. More particularly, this method consists of using electroactive polymers capable of ensuring adequate sealing, and of minimizing the energy consumption.

Another objective of this invention is to optimize machinery actuators, releasing them from the burden of supplying extra energy for sealing.

This invention presents a method of sealing machine components using electroactive materials that can be energized independently through a driver or a separate electric circuit.

Typically an electroactive polymer actuator is made from films of electroactive polymers coated on both sides with a compliant electrode material. When a voltage is applied, the polymer film can compress in thickness and expands in area. Both changes convert electrical energy to mechanical energy and provide the actuation mechanism. Depending on the nature of the electro-active polymers, this actuation mechanism can withstand large strains, produce high actuation pressures and have fast response times.

According to this invention, an electroactive polymer is placed between two or more machine components that need to be sealed. The cross-section of the electroactive polymer compresses and expands its surface when a voltage is applied across it. When the voltage is on, electro-active polymer can expand filling up the gap between the adjacent sealing surfaces and therefore providing sealing. When the voltage is off, the electro-active polymer shrinks back to its initial shape allowing the two machine parts to be moved without sealing related friction. A mirror function of this mechanism would be to have the electroactive polymer accomplish sealing in its passive state, while relaxing the component fit in the active state. More particularly, the object of this invention is to provide a method of sealing at least two machine components having associated sealing surfaces and one or more electroactive polymer actuators that change their geometry in such a way to seal the machine parts when a voltage or electric field is applied. Electroactive polymer actuators can provide a number of advantages:
1. Quality sealing for machine parts without interference frictions
2. Longer lifetime
3. Control geometry and shape
4. Cost reduction for actuators
5. Control position of mobile parts.
6. Simplify assembly of machine parts
7. Improve manufacturability of machine parts
8. Decrease overall cost of a sealing

### BRIEF DESCRIPTION OF THE DRAWINGS

FIGS. 1(a, b) show cross-sectional views through three machine parts 1, 2 and 3 that are sealed with an electroactive polymer actuator 4 placed between their sealing surfaces.

FIG. 1(c) shows a cross-section through a pair of parts 5 and 6 and an electroactive polymer 4 that provides a normal compression force.

FIGS. 2(a, b, c) show a front and two cross-sectional views of a butterfly valve that has an electroactive polymer actuator strip 4 mounted into the valve body 7, in the vicinity of the disc 8 circumference when the disc is in closed position.

FIG. 3 shows a cross-sectional view through a knife valve that has a knife plate 12 sealed on both faces by two rings 4 of electroactive polymers.

FIGS. 4(a, b, c) show a pinch valve embodying this invention that consists of an electroactive polymer 4 attached to a hose 13.

### DETAILED DESCRIPTION OF THE PREFERED EMBODIMENT

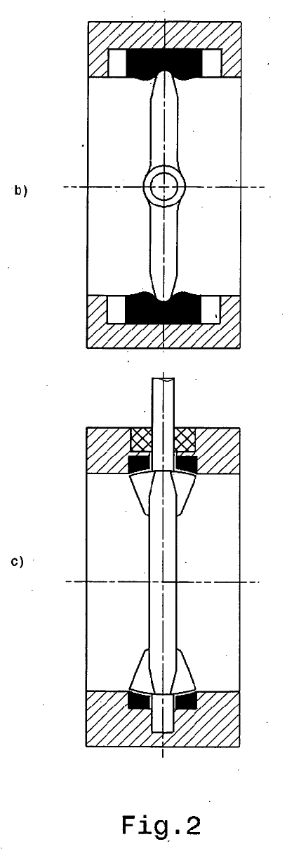

FIGS. 2(a, b, c) illustrate the basic elements of the preferred embodiment of this invention. A butterfly valve has a circumferential groove machined into its body 7 around the disc 8 circumference when closed. On this groove there is installed an annular band 4 made out of an electroactive polymer which may or may not be covered by a protective elastic membrane 10.

When the valve is closed and a seal is required, the voltage is removed from the electro-active polymer strip 4. These electroactive polymers then relax and interfere with the disc 8 around the disc circumference. When the valve needs to open, a voltage is applied to the electro-active polymer actuator 4 that compresses and therefore allows disc 8 to move freely. The valve actuator then rotates disc 8 via torque transmission through shaft 9. The driver of the electro-active polymer actuator can turn off the circuit in order to stop disc 8 in a desired intermediate open position. A mirror function of this mechanism would be to have the electroactive polymer ring 4 accomplish sealing in its active state when energized, while relaxing the component fit in its passive state.

This invention provides an optimized valve packaging at a lower cost, since the valve main actuator is no longer required to deliver the extra torque to overcome friction and elastic deformation of sealing materials.

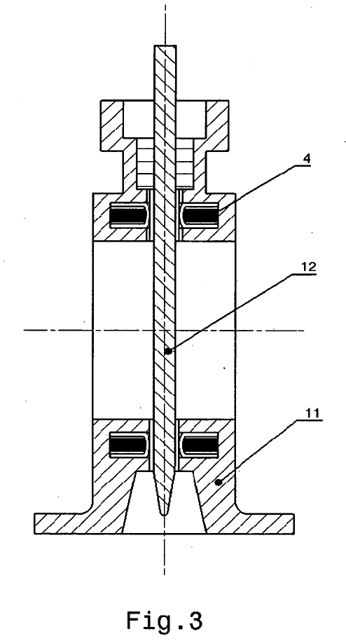

As is shown in FIG. 3, a knife 12 can move freely up and down when the electro-active polymer actuator rings are energized (radially expanded). According to this embodiment, de-energizing rings 4 (axially expanded) they interfere with knife 12 and can stop it in any desired intermediate position. In closed position, the pair of electro-active polymer bands 4 seals the knife 12.

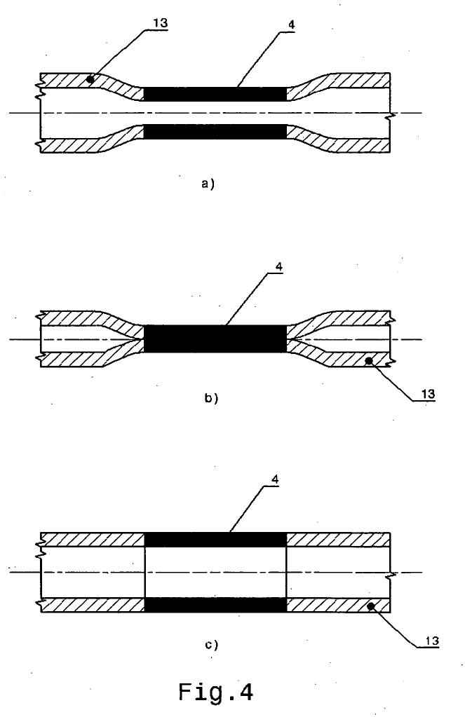

In the FIGS. 4(a, b, c), the electro-active polymer actuator 4 is connected to a hose 13. Energizing the electro-active polymer actuator 4, compresses the material and seals the circuit as in FIG. 4b. De-energizing the electro-active polymer allows it to expand to its natural state, thus increasing the cross-sectional area of the passage. The electro-active polymer geometry and thus the cross sectional area can be manipulated as desired by varying the applied voltage.

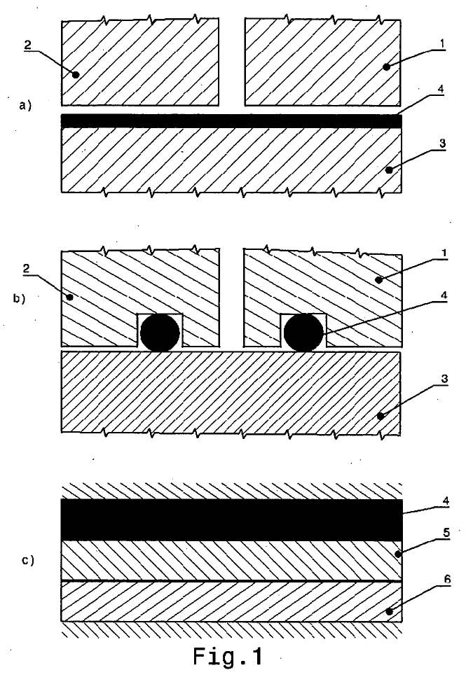

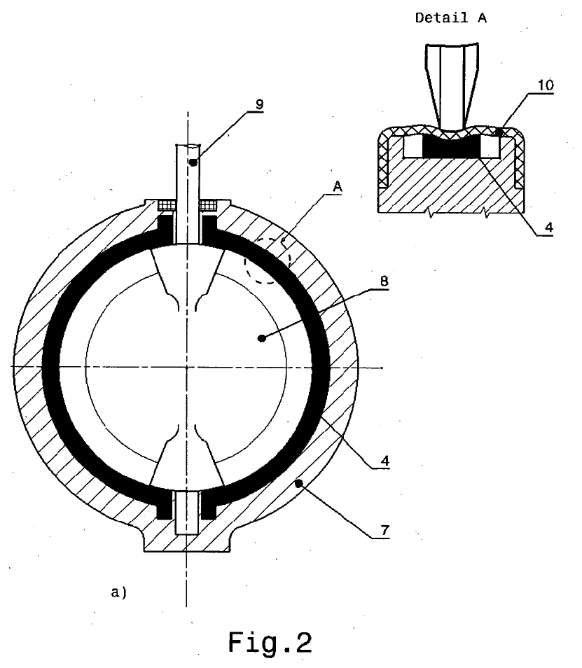

According to FIG. 1c, an electro-active polymer belt 4 can provide a compressing force in order to accomplish sealing between sealing faces of parts 5 and 6.

1. A method of sealing at least two machine components having associated sealing surfaces and one or more electroactive materials that change their geometry under an applied voltage or electric field in such a way as to perform the sealing of the machine parts.

2. A method according to claim 1 where the electroactive material is used as an actuator for sealing machine parts.

3. A method according to claim 1 where the electroactive material can perform sealing when subject to an applied voltage or electric field.

4. A method according to claim 1 where an electroactive material can perform sealing when the applied voltage is removed.

5. A method according to claim 1 where the electroactive material is used to improve the response time of a moving machine part.

6. A method according to claim 1 where the electroactive material is used to apply a compressive load on sealing surfaces.

7. A method according to claim 1 where the electroactive material is used to control the size of a cross-sectional area.
